(19) United States
(12) Patent Application Publication
(10) Pub. No.: US 2009/0268441 A1
(43) Pub. Date: Oct. 29, 2009

(54) LIGHT EMITTING DIODE ILLUMINATION DEVICE

(75) Inventor: GA-LANE CHEN, Santa Clara, CA (US)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/333,632

(22) Filed: Dec. 12, 2008

(30) Foreign Application Priority Data
Apr. 23, 2008 (CN) 200810301265.X

(51) Int. Cl. F21L 4/08

(52) U.S. Cl. 362/192

(57) ABSTRACT

The disclosure provides a light emitting diode illumination device comprising a plurality of light emitting diodes, a holder, a first circuit board provided on the holder, a rechargeable battery, a generator, a turbine and a solar cell panel. The first circuit board has a first surface on which the plurality of light emitting diodes is installed and is electrically connected to the first circuit board. The rechargeable battery is electrically connected to the first circuit board to provide power to the plurality of light emitting diodes. The solar cell panel is electrically connected to the rechargeable battery to convert solar energy into electrical power, and the turbine is mechanically coupled to the generator to convert wind energy into electrical power, and charge the rechargeable battery.

### BACKGROUND

1. Field of the Invention

The disclosure relates to a light emitting diode illumination device, and particularly to a light emitting diode illumination device using green energy power sources.

2. Description of Related Art

With an optical spectrum providing a chromatic diagram approaching natural sunlight, and high illumination efficiency, LEDs are gaining popularity in lighting devices such as streetlamps, standing lamps, industrial lighting, and many other applications. A scientific literature can be referred for related researches: “Solid State Lighting: Toward Superior Illumination”, published on No. 10, Vol. 93, Proceeding of the IEEE, October of 2005. However, light emitting diode devices normally require power supply from an external source or the local grid. With current concerns over environmental friendliness as well as soaring conventional energy costs, alternative self-generating and recycled energy sources are becoming consistently preferable.

### SUMMARY

Thus, what is needed is a light emitting diode illumination device powered by alternative renewable energy sources, addressing the limitations described.

The disclosure provides a light emitting diode illumination device comprising a plurality of light emitting diodes, a holder, a first circuit board provided on the holder, a rechargeable battery, a generator, a turbine and a solar cell panel. The first circuit board has a first surface on which the plurality of light emitting diodes is installed and is electrically connected to the first circuit board. The rechargeable battery is electrically connected to the first circuit board to provide power to the plurality of light emitting diodes. The solar cell panel is electrically connected to the rechargeable battery to convert solar energy into electrical power, and the turbine is mechanically coupled to the generator to convert wind energy into electrical power, and charge the rechargeable battery. Compared to prior art, the light emitting diodes illumination device disclosed by the disclosure can implement recycling of clean energy by powering itself with solar energy and wind energy.

### BRIEF DESCRIPTION OF THE DRAWINGS

FIG. 1 is an illustration drawing of an exemplary light emitting diode illumination device as disclosed.

FIG. 2 is a structural illustration drawing of a solar cell panel and a rechargeable battery of the disclosure as disclosed.

FIG. 3 is a structural illustration drawing of a turbine as disclosed.

FIG. 4 is an illustration drawing of another exemplary light emitting diode illumination device as disclosed.

### DETAILED DESCRIPTION OF THE EMBODIMENTS

A detailed description will follow by referring to the accompanied drawings.

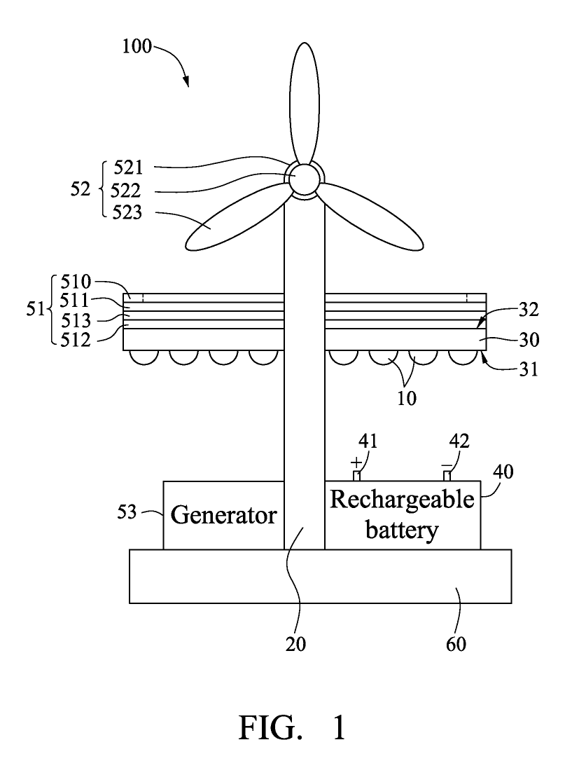

FIG. 1 shows a light emitting diode illumination device according to one embodiment of the disclosure. The light emitting diode illumination device 100 comprises a plurality of light emitting diodes 10, a holder 20, a first circuit board 30 attached to the holder 20, a rechargeable battery 40, a solar cell panel 51, a turbine 52, a generator 53 and a support 60 supporting the holder 20.

The first circuit board 30 comprises a first surface 31 and a second surface 32 opposite to the first surface 31. The plurality of light emitting diodes are provided on the first surface 31 and electrically connected to the first circuit board 30. In this embodiment, the diameter of each light emitting diode 10 is 5 millimeters, and each light emitting diode has 25 watt when it is turned on. Those light emitting diodes are arranged in matrix form on the first surface 31.

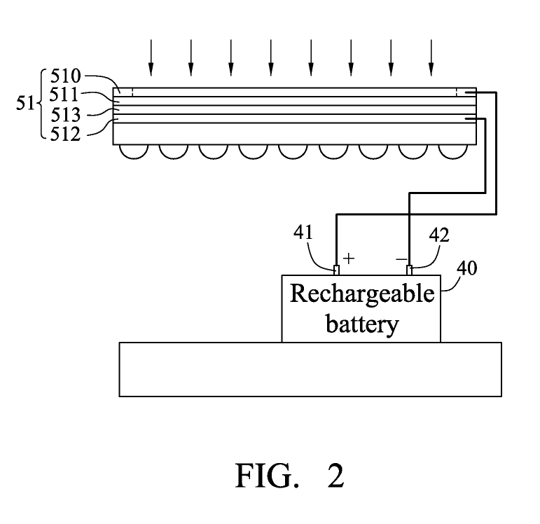

The solar cell panel 51 is provided on the second surface 32 of the first circuit board 30. Please refer to FIG. 1 and FIG. 2, the solar cell panel 51 comprises a front electrode 510, a transparent conductive layer 511, a back electrode 512, and a photovoltaic semiconductor layer 513 arranged between the transparent layer 511 and the rear electrode 512. Sunlight injects into the transparent conductive layer 511 through the front electrode 510. When the transparent conductive layer 511 is injected by sunlight, the photovoltaic semiconductor layer 513 forms a voltage between the front electrode 510 and the back electrode 512, and realizes photo-electron conversion. The rechargeable battery 40 has a positive electrode 41 and a negative electrode 42. When the front electrode 510 is electrically connected to the positive electrode 41, and the back electrode 512 is electrically connected to the negative electrode 42, the rechargeable battery 40 is recharged by the first energy conversion sub-unit 51. In this embodiment, the front electrode 510 and the back electrode 511 are electrically connected to the front electrode 41 and the negative electrode 42 respectively through conductive wires, and those wires are hidden inside the holder 20.

The turbine 52 comprises a body 521, a rotating shaft 522, and a plurality of blades 523. The plurality of blades 523 is provided on the rotating shaft 522, the rotating shaft 522 is connected to the body 521, and the body 521 is fixed on the holder 20. In this embodiment, the body 521 is fixed on the top of the holder 20, and a generator 53 and a rechargeable battery 40 are provided on the support 60.

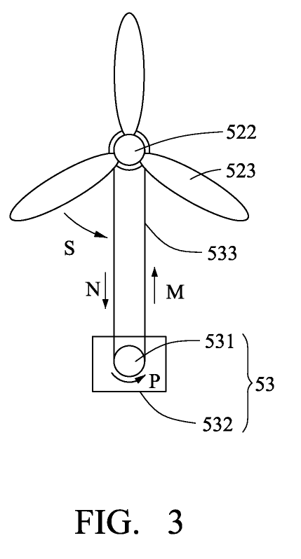

Please refer to FIG. 1 to FIG. 3, the generator 53 comprises a rotor 531 and a stator 532. The rotor 531 is connected to the rotating shaft 522 by a driving belt 533. The plurality of blades 523 rotates the rotating shaft in a direction as the arrow in FIG. 3 shows, and the driving belt 533 rotate. Therefore, the rotor 531 of the generator 53 rotates in a direction as an arrow P shows, and drives the stator 532 to output a voltage. Therefore, the generator 53 generates electrical power. The negative and positive voltage outputs of the generator 53 are connected to the anode 41 and cathode 42 of the rechargeable battery respectively to form a circuit, such that power of the generator 53 is conserved by the rechargeable battery 40.

The driving belt 533 is provided inside the holder 20. The generator 53 and the rechargeable battery 40 can be installed underground to extend their lifetime. The light emitting diodes illustration device 100 further comprises a control unit to turn on or turn off the solar panel and the turbine 52. The turbine 52 is usually turned on, and the solar cell panel 51 is usually off during the evening (generally is six o'clock in the evening to six o'clock next morning, with time settings changed to correspond to different seasons).

The exemplary light emitting diode illumination device 100 can be implemented to convert solar energy and wind energy into electrical energy to provide power for the plurality of light emitting diodes 10 through the solar cell panel 51 and the turbine 52. The light emitting diode illumination device 100 implements recycle of green energy, and provides a longer lifetime than other light emitting diode devices.

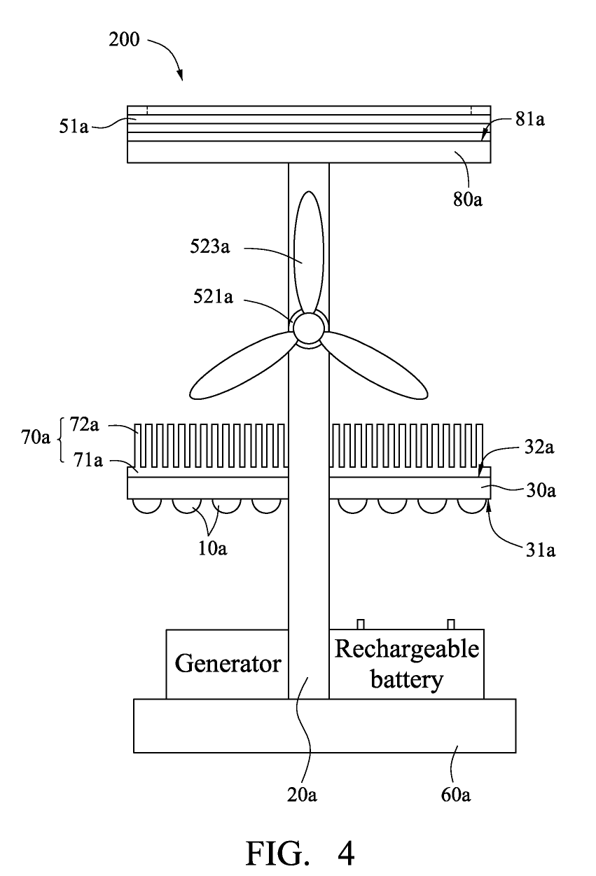

FIG. 4 shows another exemplary light emitting diode illumination device 200, differing from device 100 only in the inclusion of a second circuit 80a and a heat dissipation unit 70a.

A second circuit board 80a is provided on the holder 20a on one side opposite to the first circuit board 30a. The other side of the second circuit 80a, away from the first circuit 30a is a third surface 81a, on which the solar cell panel 51a is provided. In this exemplary embodiment, the second circuit board 80a is disposed on a top of the holder 20a.

The body 521a is fixed to a holder 20a between the first circuit board 30a and the second circuit board 80a, and blades 523a rotate between them.

A heat dissipation unit 70a is provided on a second surface 32a of the first circuit board 30a, which comprises a heat dissipation substrate 71a and a plurality of heat dissipation fins 72a provided on the second surface 32a. The heat dissipation substrate 71a and the plurality of fins 72a can be integrally formed. The heat dissipation substrate 71a is attached on the second surface 32a by a clip. The heat dissipation fins dissipate heat generated by the plurality of light emitting diodes 10a.

When rotation of the plurality of blades 533a converts wind energy into electrical power, it also accelerates airflow around the heat dissipation unit 70a, and effectively dissipates heat from the plurality of light emitting diodes 10a. Therefore, safety and lifetime of the light emitting diode illumination devices 200 are enhanced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light emitting diode illumination device, comprising:
a plurality of light emitting diodes;
a holder;
a first circuit board mounted on the holder, the plurality of light emitting diodes disposed on the first circuit board;
a rechargeable battery electrically connected to the first circuit board to provide power to the plurality of light emitting diodes;
a solar cell panel electrically connected to the rechargeable battery;
a turbine mounted on the holder; and
a generator mechanically coupled to the turbine and electrically connected to the rechargeable battery to convert wind energy into electrical power and charge the rechargeable battery.

2. The light emitting diode illumination device as claimed in claim 1, wherein the solar cell panel is mounted on an opposite side of the first circuit board to the light emitting diodes.

3. The light emitting diode illumination device as claimed in claim 1, wherein the rechargeable battery has a positive electrode and a negative electrode, and the solar cell panel has a front electrode and a rear electrode, the positive electrode of the rechargeable battery is connected to the front electrode of the solar cell panel, and the negative electrode of the rechargeable battery is connected to the rear electrode of the solar cell panel.

4. The light emitting diode illumination device as claimed in claim 1, further comprising a base to which the holder is fixed, wherein the rechargeable battery and the generator are mounted on the base.

5. The light emitting diode illumination device as claimed in claim 1, wherein the turbine comprises a rotating shaft rotatably mounted on the holder and a plurality of blades fixed on the rotating shaft, and the generator comprises an input shaft coupled to the rotating shaft.

6. A light emitting diode illumination device, comprising:
a plurality of light emitting diodes;
a holder;
a first circuit board mounted on the holder, the plurality of light emitting diodes disposed on one side the first circuit board;
a rechargeable battery electrically connected to the first circuit board to provide power to the plurality of light emitting diodes;
a second circuit board disposed on the top of the holder;
a solar cell panel disposed on one side of the second circuit board and electrically connected to the rechargeable battery;
a turbine mounted on the holder;
a heat dissipation fins disposed on an opposite side of the first circuit board to the plurality of light emitting diodes; and
a generator mechanically coupled to the turbine and electrically connected to the rechargeable battery to convert wind energy into electrical power and charge the rechargeable battery.

7. The light emitting diode illumination device as claimed in claim 6, wherein the heat dissipation fins are disposed adjacent to the turbine.

8. The light emitting diode illumination device as claimed in claim 6, wherein the rechargeable battery has a positive electrode and a negative electrode, and the solar cell panel has a front electrode and a rear electrode, the positive electrode of the rechargeable battery is connected to the front electrode of the solar cell panel, and the negative electrode of the rechargeable battery is connected to the rear electrode of the solar cell panel.

9. The light emitting diode illumination device as claimed in claim 6, further comprising a base to which the holder is fixed, wherein the rechargeable battery and the generator are mounted on the base.

10. The light emitting diode illumination device as claimed in claim 6, wherein the turbine comprises a rotating shaft rotatably mounted on the holder and a plurality of blades fixed on the rotating shaft, and the generator comprises an input shaft coupled to the rotating shaft.

11. The light emitting diode illumination device as claimed in claims 6, wherein the heat dissipation unit comprises a base plate and a plurality of heat dissipation fins provided on the base plate.

12. The light emitting diode illumination device as claimed in claim 6, wherein the base plate and the plurality of heat dissipation fins are formed integrally.
